(19) United States
(12) Patent Application Publication
(10) Pub. No.: US 2009/0049851 A1
(43) Pub. Date: Feb. 26, 2009

(54) TRANSPORT REFRIGERATION DAMPER ASSEMBLY

(75) Inventor: Basil Regan, Athenry (IE)

Correspondence Address: MICHAEL BEST & FRIEDRICH LLP, 100 E WISCONSIN AVENUE, Suite 3300, MILWAUKEE, WI, 53202, US

(73) Assignee: THERMO KING CORPORATION, Minneapolis, MN (US)

(21) Appl. No.: 11/843,416

(22) Filed: Aug. 22, 2007

(51) Int. Cl. B60H 1/32

(52) U.S. Cl. 62/239

(57) ABSTRACT

A damper assembly for a transport unit that defines a space and that includes a refrigeration system. The damper assembly includes a housing that is coupled to the transport unit, and that has an inlet and an outlet in communication with the conditioned space. The damper assembly also includes a blower assembly that is in communication with the inlet and the outlet, and that has a rotatable blower member that is configured to generate an airflow from the inlet toward the outlet. An airfoil-shaped damper blade is pivotally coupled to the housing about an axis offset from a center of the damper blade, and is positioned adjacent and in close proximity to the blower member, and is further positioned between the blower assembly and the outlet. The damper blade is pivotable about the axis between an open position and a closed position to selectively direct the airflow through the outlet.

### BACKGROUND

The present invention relates to a damper assembly for a transport unit. More particularly, the present invention relates to a damper assembly that includes a blower assembly and a damper that regulates airflow into a conditioned space of the transport unit.

Transport units (e.g. trucks, tractor-trailer combinations) often transport cargo that must be maintained at predetermined conditions. These transport units have one or more spaces that are conditioned by a refrigeration system that includes a compressor, a condenser, an evaporator, and a blower or fan located in a housing. The refrigeration system is typically located adjacent a front side of the transport unit in a relatively small compartment so that the size of the conditioned spaces can be optimized.

Generally, transport unit refrigeration systems operate in a cooling mode and a heating mode depending at least in part upon the temperature of the conditioned space and the ambient temperature of the environment outside the transport unit. Air that is cooled or heated by the refrigeration system is drawn by the fan over the evaporator and discharged into the space.

The refrigeration system also operates in a defrost mode to limit formation of ice and/or frost on the evaporator. During operation of the refrigeration system in the defrost mode, relatively warm refrigerant is directed through the evaporator, which warms the air that surrounds the evaporator. In some existing transport units, air that is warmed by the evaporator in the defrost mode is discharged by the fan directly into the space, which exposes the temperature sensitive cargo to adverse or undesirable conditions.

In other existing transport units, a damper is placed downstream of the fan to inhibit warm air that is discharged from the fan during the defrost mode from entering the conditioned space. Generally, the damper is a flat plate that is in an open position when the refrigeration system is in the cooling or heating modes, and is moved to a closed position when the refrigeration system is in the defrost mode. The dampers pivot or rotate between the open and closed positions about an axis that is at an end of the damper or at a center of the damper. Often, existing dampers limit the efficiency of the fan by partially obstructing the airflow. The efficiency of the fan is also limited because these dampers deflect the airflow from the fan in many different directions. In addition, some dampers create a void or dead zone on a side of the damper that is opposite the fan, which further limits the efficiency of the fan.

Typically, existing dampers cannot be positioned relatively close to the fan without interfering with and impeding the efficiency of the fan. Instead, these dampers are often located in an exhaust duct that is coupled to the fan housing. Locating these dampers in the exhaust duct takes up additional space in the compartment. In some transport units, the size of one or more components of the refrigeration system (e.g., evaporator coil, compressor, etc.) are reduced to compensate for the area taken up by the fan housing and the damper, which can limit the refrigeration capacity of the refrigeration system.

### SUMMARY

In one embodiment, the invention provides a damper assembly for a transport unit that defines a space and includes a refrigeration system that conditions the space. The damper assembly includes a housing that is coupled to the transport unit, and that has an inlet and an outlet in communication with the conditioned space. The damper assembly also includes a blower assembly that is disposed in the housing, and that is in communication with the inlet and the outlet. The blower assembly includes a rotatable blower member that is configured to generate an airflow from the inlet toward the outlet. The damper assembly further includes an airfoil-shaped damper blade that is pivotally coupled to the housing about an axis that is offset from a center of the damper blade. The damper blade is positioned adjacent and in close proximity to the blower member, and is further positioned between the blower assembly and the outlet. The damper blade is pivotable about the axis between an open position and a closed position to selectively direct the airflow through the outlet.

In another embodiment, the invention provides a damper assembly for a transport unit that defines a space and includes a refrigeration system that conditions the space. The damper assembly includes a housing that is coupled to the transport unit. The housing includes an inlet and an outlet that is in communication with the conditioned space, and an upper portion and a lower portion. The damper assembly also includes a blower assembly and a damper blade. The blower is disposed in the housing, and is in communication with the inlet and the outlet. The blower assembly includes a rotatable blower member that is configured to direct an airflow from the inlet toward the outlet. The damper blade includes a shaft that is pivotally coupled to the housing and that defines an axis. The damper blade is positioned adjacent and in close proximity to the blower member and is pivotable about the axis between an open position and a closed position. The damper blade further includes a first end that has a thickness and a second end that has a thickness that is substantially less than the thickness of the first end such that when the damper blade is in the open position, the first end is configured to receive the airflow from the blower assembly over a plurality of angles to direct the airflow through the outlet in a substantially uniform horizontal direction.

In yet another embodiment, the invention provides a damper assembly for a transport unit that defines a space and includes a refrigeration system that conditions the space. The damper assembly includes a housing that is coupled to the transport unit. The housing includes an inlet and an outlet that is in communication with the conditioned space, and an upper portion and a lower portion. The damper assembly also includes a blower assembly that is disposed in the housing, and that is in communication with the inlet and the outlet. The blower assembly includes a rotatable blower member that is configured to direct an airflow from the inlet toward the outlet. The damper assembly further includes an airfoil-shaped damper blade The damper blade includes a shaft that is pivotally coupled to the housing and that defines an axis that is offset from a center of the damper blade. The damper blade is positioned adjacent and in close proximity to the blower member, and is pivotable about the axis between an open position and a closed position to selectively direct the airflow through the outlet. The damper blade is further positioned between the blower assembly and the outlet. The damper blade further includes a first end that has a thickness and a second end that has a thickness substantially less than the thickness of the first end such that when the damper blade is in the open position, the first end is configured to receive the airflow from the blower assembly over a plurality of angles to direct the airflow through the outlet in a substantially uniform horizontal direction.

Other aspects of the invention will become apparent by consideration of the detailed description and accompanying drawings.

### BRIEF DESCRIPTION OF THE DRAWINGS

FIG. 1 is a side view of a transport unit defining a conditioned space and including a compartment.

FIG. 2 is a front view of a wall of the compartment of FIG. 1, and a portion of a refrigeration system and a damper assembly that is disposed in the compartment.

FIG. 3 is a perspective view of a portion of the damper assembly of FIG. 2 in communication with the space through the wall.

FIG. 4 is a front view of the damper assembly of FIG. 3 with the wall removed.

FIG. 5 is a perspective view of the damper assembly of FIG. 4 including a blower assembly and a damper blade.

FIG. 6 is a side view of a portion of the blower assembly and the damper blade of FIG.

FIG. 7 is a perspective view of the damper blade of FIG. 5.

FIG. 8 is a side view of the damper blade of FIG. 7.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

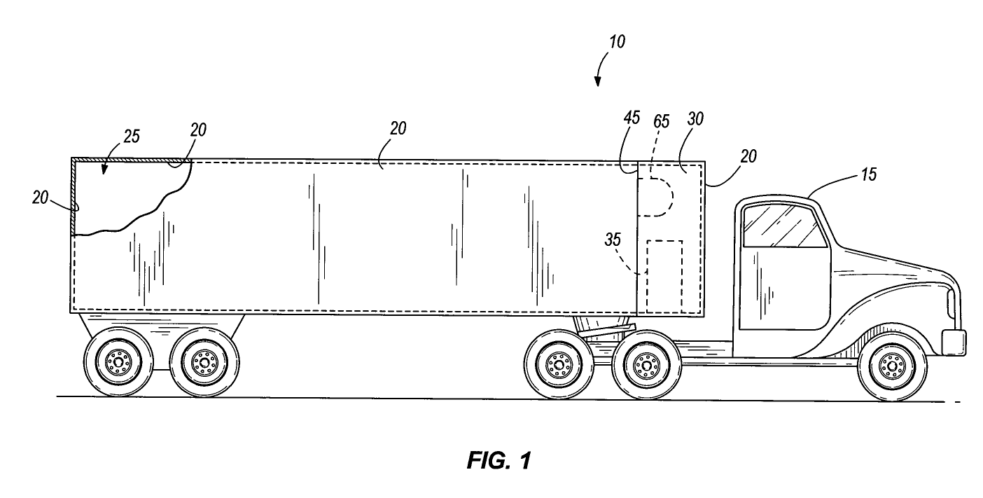

FIG. 1 shows a transport unit 10 that is suitable for storing and transporting perishable cargo (e.g., food, agricultural goods, or medical supplies, etc.) that must be maintained at predetermined conditions. The illustrated transport unit 10 is a trailer that is coupled to a vehicle 15 (e.g., straight truck, tractor, etc.) for shipping perishable cargo in a tractor-trailer combination. In other embodiments, the transport unit 10 can include a free-standing shipment container. Hereinafter, the term “transport unit” shall be used to represent all such shipment containers and trailers, and shall not be construed to limit the invention's application solely to a trailer in a tractor-trailer combination.

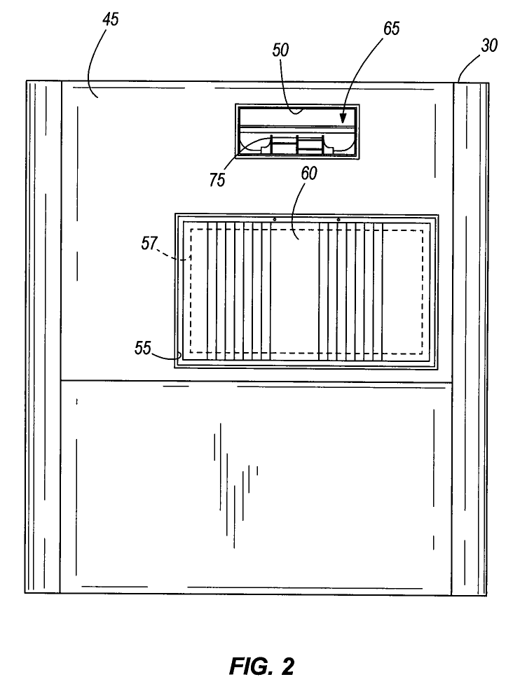

The transport unit 10 includes transport walls 20 that define a space 25, a compartment 30 that is positioned adjacent a forward end of the transport unit 10, and a refrigeration system 35 that is disposed in the compartment 30. The transport unit 10 also includes side walls 40 disposed inward of the transport walls 20, and a compartment wall 45 that interconnects the side walls 40. FIGS. 1, 2, 4, and 5 show that the compartment 30 is partially defined by the transport walls 20, and is further defined by the side walls 40 and the compartment wall 45. The compartment wall 45 is disposed on an interior side of the compartment 30, and partially separates the refrigeration system 35 from the space 25. As shown in FIG. 2, the compartment 30 also includes a first opening 50 and a second opening 55 that extend through the compartment wall 45.

The refrigeration system 35 is in communication with the space 25 via the first opening 50 and the second opening 55 to maintain the space 25 at predetermined conditions (e.g., temperature, humidity, etc.) during transportation and storage in order to preserve the quality of the cargo. Generally, the refrigeration system 35 is operable in a refrigeration mode (e.g., a cooling mode, a heating mode) and a defrost mode, and includes one or more refrigeration components (not entirely shown), such as an evaporator 57, one or more compressors, a condenser, one or more fans, a receiver, and one or more expansion valves. Refrigerant is routed through the components of the refrigeration system 35. Such arrangements are known in the art.

The evaporator 57 is positioned in the compartment 30 behind the compartment wall 45, and is in communication with the conditioned space 25 through the compartment wall 45 via the first opening 50. In the illustrated embodiment, a screen or cover 60 is placed over the first opening 50 to inhibit debris and other material from entering the compartment 30, and to assist with directing air into the compartment 30 from the conditioned space 25.

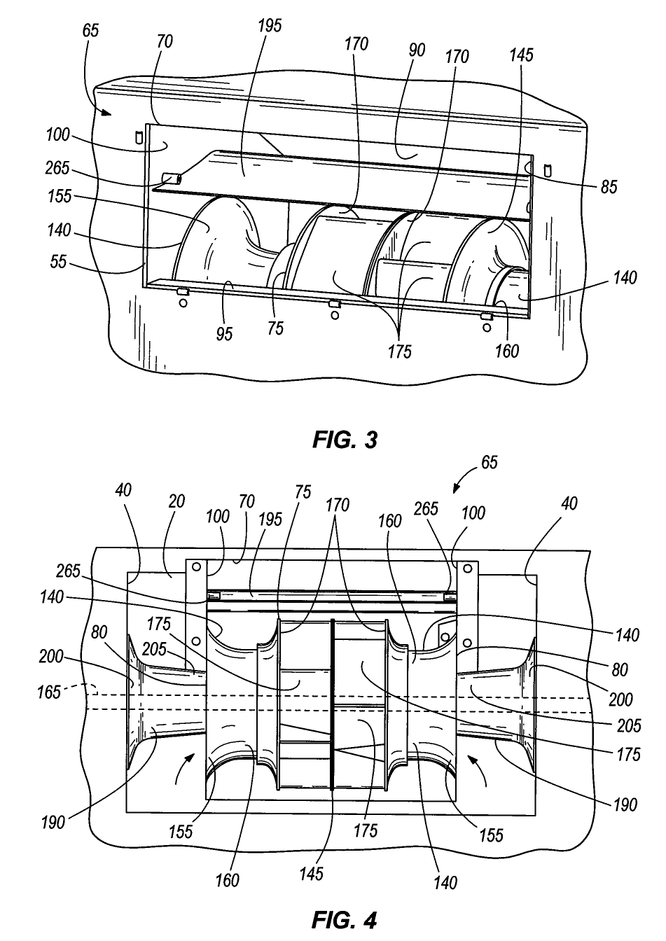

FIGS. 2-6 show that the transport unit 10 also includes a damper assembly 65 that has a housing 70 and a blower assembly 75. FIGS. 3 and 4 show that the housing 70 is coupled to the transport unit 10 within the compartment 30, and is positioned adjacent the second opening 55. As illustrated in FIGS. 3-6, the housing 70 includes two inlets 80, an outlet 85, an upper wall portion 90, a lower wall portion or housing cover 95, and side wall portions 100. Each inlet 80 is disposed adjacent a lateral end of the blower assembly 75 and is in communication with the outlet 85 through the blower assembly 75. The inlets 80 are further in communication with the first opening 50 to receive air from the conditioned space 25.

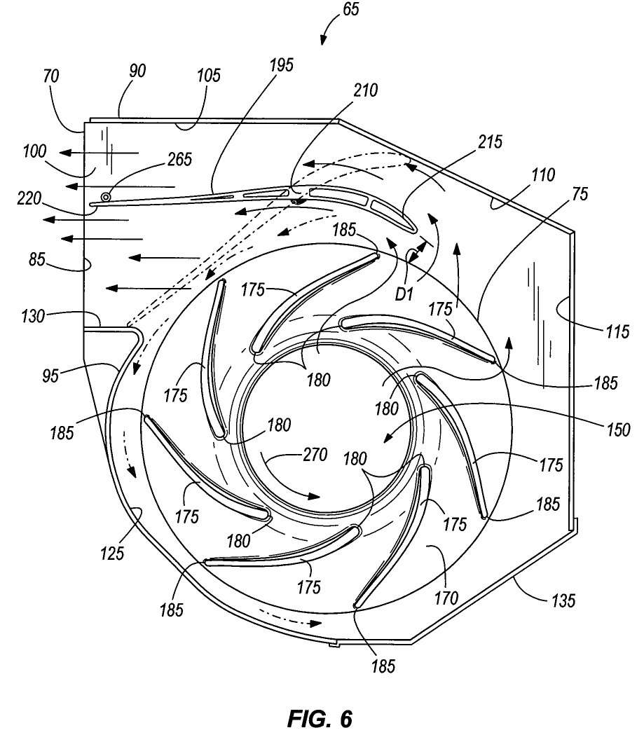

FIGS. 3 and 6 show that the outlet 85 extends across a width of the housing 70, and is in communication with the second opening 55 so that air from the inlets 80 can be directed by the blower assembly 75 through the second opening 55 and into the conditioned space 25. The side wall portions 100 define lateral edges of the outlet 85, and interconnect the upper wall portion 90 and the housing cover 95.

As shown in FIG. 6, the upper wall portion 90 defines an upper side of the outlet 85, and includes a first wall segment 105, a second wall segment 110, and a third wall segment 115. The illustrated first wall segment 105 is disposed substantially horizontal, and the third wall segment 115 is disposed substantially vertical. The second wall segment 110 interconnects the first wall segment 105 and the third wall segment 115, and is angularly disposed between the first wall segment 105 and the third wall segment 115 to generally direct air toward the outlet 85.

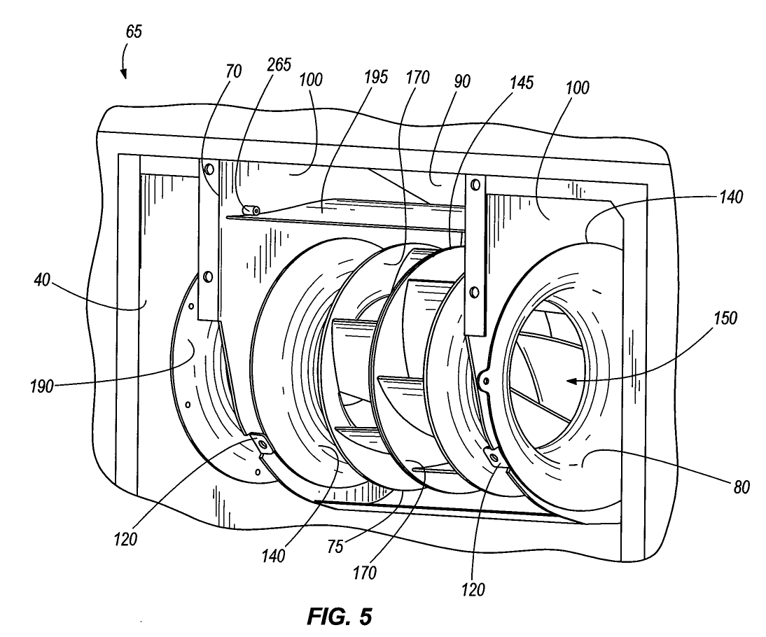

FIGS. 3 and 6 show that the housing cover 95 is disposed adjacent a forward portion of the blower assembly 75, and is attached to the compartment wall 45 to partially enclose the blower assembly 75 within the housing 70. As shown in FIG. 5, the illustrated housing cover 95 is attached to the blower assembly 75 via tabs 120 (FIG. 5) that extend inward from the side wall portions 100, and fasteners (e.g., bolt, screw, etc.) that can be extended through the tabs 120 and coupled to the housing cover 95. As shown in FIG. 6, the housing cover 95 includes a blower portion 125 and a ledge portion 130. The blower portion 125 is spaced apart from the blower assembly 75 and has a curvature that substantially corresponds to the curvature of a circumference of the blower assembly 75.

The ledge portion 130 is coupled to the blower portion 125, and extends substantially horizontally from the blower portion 125 toward the outlet 85 to partially define a lower portion the outlet 85. In the illustrated embodiment, the ledge portion 130 is substantially planar. In other embodiments, the ledge portion 130 may be curved. In still other embodiments, the ledge portion 130 may extend generally upward or downward from the blower portion 125 toward the outlet 85.

The housing 70 also includes a plate 135 that is coupled to the third wall segment 115, and is further coupled to an end of the housing cover 95 that is opposite the ledge portion 130 to enclose the blower assembly 75 within the housing 70, and so that air can be generally directed toward the outlet 85. In other embodiments, the upper wall portion 90 and the housing cover 95 may be formed as a single piece, extending continuously around the blower assembly. In still other embodiments, the upper wall portion 90 can be directly coupled to the housing cover 95.

The blower assembly 75 is disposed in the housing 70, and is in communication with the inlets 80 and the outlet 85 to generate an airflow from the inlets 80 toward the outlet 85. FIGS. 3-5 show that the blower assembly 75 includes support members 140 and a rotatable blower member 145. As shown in FIGS. 4-6, the support members 140 and the blower member 145 cooperate to define a hollow portion 150 of the blower assembly 75 that is in communication with the inlets 85. The support members 140 extend through the side wall portions 100 and are rigidly attached to the housing 70. Each of the support members 140 includes a first end 155 that is attached to the side wall portions 100, and a second end 160 that is opposite the first end 155 to rotatably support the blower member 145. The illustrated support members 140 are generally tapered from the first end 155 to the second end 160.

As shown in FIG. 4, the blower member 145 is rotatably coupled to a shaft 165 that is driven by an engine or prime mover (not shown) of the transport unit 10 via belts (not shown) or other power transfer devices that transfer power from the prime mover to the shaft 165. The blower member 145 is further rotatably supported by the second ends 160. In the illustrated embodiment, the blower assembly 75 includes one rotatable blower member 145. In other embodiments, the blower assembly 75 may include more than one blower member 145.

FIGS. 3-6 show that the blower member 145 includes fan blade sections 170 that have a plurality of fan blades 175. The fan blade sections 170 are rotatably coupled to the shaft 165. In the illustrated embodiment, the blower member 75 includes two fan blade sections 170. In other embodiments, the blower member 75 can include fewer or more than two fan blade sections 170.

FIG. 6 shows one fan blade section 170 that has seven fan blades 175 radially disposed around the fan blade section 170, although fewer or more than seven fan blades 175 are possible and considered herein. Each fan blade 175 includes an inner end 180 that is adjacent the hollow portion 150, and an outer end 185 that is adjacent a perimeter of the fan blade section 170. Each fan blade 175 is further coupled to sides of the fan blade section 170, and extends radially outward from adjacent the hollow portion 150. The fan blades 175 are angularly spaced from each other such that the inner ends 180 of two adjacent fan blades 175 are spaced closer together or in closer proximity than the outer ends 185 of the two adjacent fan blades 175. In the illustrated embodiment, each fan blade 175 is tapered from the inner end 180 toward the outer end 185, and is further curved from the inner end 180 toward the outer end 185. In other embodiments, the fan blades 175 may have a substantially uniform thickness. In still other embodiments, the fan blades 175 may have substantially planar cross-sections.

FIGS. 3-5 show that the damper assembly 65 also includes inlet members 190 and a damper blade 195. Each inlet member 190 partially defines one inlet 80, and includes a first end 200 that is attached to one side wall 40, and a second end 205 that extends through the housing 70 and partially into the hollow portion 150. Each illustrated inlet member 190 is tapered from the first end 200 toward the second end 205 to direct air into the hollow portion 150 of the blower assembly 75. In other embodiments, the inlet members 190 may be substantially straight between the first ends 200 and the second ends 205. In still other embodiments, the damper assembly 65 may be without the inlet members 190 positioned between the side walls 40 and the housing 70.

The damper blade 195 extends laterally within the housing 70 across a width of the housing 70 and the outlet 85, and is positioned adjacent and in close proximity to the blower assembly 75. The damper blade 195 is positioned between the outlet 85 and the blower assembly 75, and is movable between an open position and a closed position to selectively direct the airflow generated by the blower assembly 75 through the outlet 85. The damper blade 195 can be formed form any suitable material (e.g., metals including aluminum and steel, plastics, composites, polymers, structural polymer foam, etc.). The illustrated damper blade 195 is formed by an extrusion process. In some embodiments, the damper blade 195 can be formed by a molding process. In other embodiments, the damper blade 195 can be formed using other suitable processes (e.g., casting, machining, etc.).

FIGS. 6-8 show that the damper blade 195 is defined by an airfoil shape, and includes a body 210 that has a first end 215 and a second end 220. The illustrated damper blade 195 has hollow portions 225 that extend laterally through the body 210 to reduce the weight of the damper blade 195. In other embodiments, the body 210 can be substantially solid.

The first end 215 has a thickness and the second end 220 has a thickness that is less than the thickness of the first end 215. The first end 215 is curved, and defines a leading edge of the airfoil-shaped body 210 that limits separation of the airflow adjacent the first end 215, and that receives air over a plurality of angles. The second end 220 defines a trailing edge of the airfoil-shaped body 210 that reduces air drag losses adjacent the second end 220. The damper blade 195 is generally tapered from the first end 215 to the second end 220. Generally, the first end 215 is spaced apart from the blower assembly 75 when the damper blade 195 is in the open position so that the damper blade 195 does not adversely affect or impact the efficiency of the blower assembly 75. As shown in FIG. 6, the first end 215 is located a distance D1 from the perimeter of the blower assembly 75 when the damper blade 195 is in the open position. In the illustrated embodiment, the distance D1 is approximately 20 millimeters from the perimeter of the blower assembly 75. In other embodiments, the distance D1 can be smaller or larger than 20 millimeters, depending on the size of the blower assembly 75.

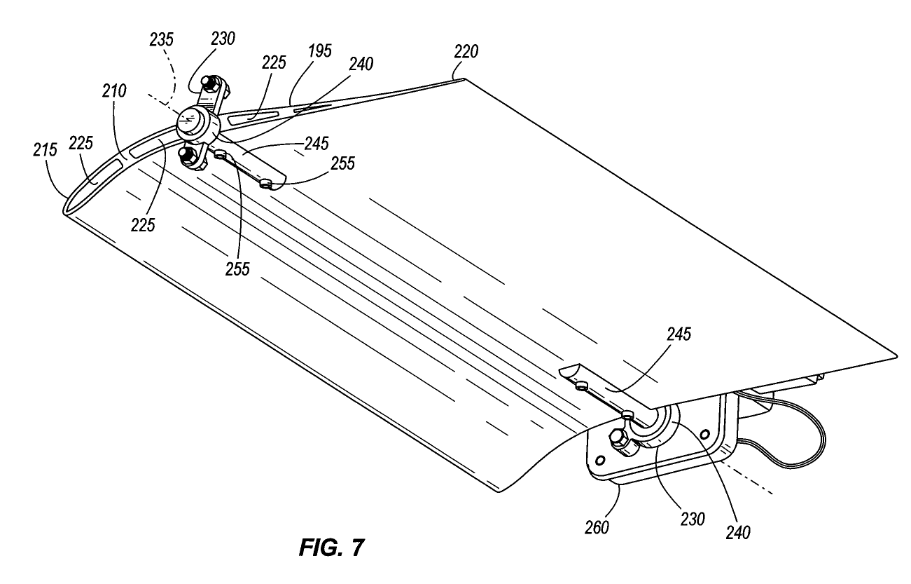

FIG. 7 shows that the damper blade 195 also includes pivot members 230 that are coupled to and extend laterally outward from the damper blade 195. The pivot members 230 define a pivot axis 235, and couple the damper blade 195 to the side wall portions 100 of the housing 70 (FIGS. 3-5) so that the damper blade 195 is pivotable about the pivot axis 235 between the open position and the closed position. As shown in FIGS. 6 and 7, the pivot axis 235 is offset from a center of the damper blade 195 between the first end 215 and the second end 220 such that the first end 215 is closer to the pivot axis 235 than the second end 220. The pivot axis 235 is offset so that when the damper blade 195 is in the closed position, the first end 215 can be engaged with the upper wall portion 90, and the second end 220 can be engaged with the ledge portion 130.

As shown in FIG. 7, each of the pivot members 230 includes an attachment portion 240 that is attached to the housing 70, and a pivot shaft 245 that is attached to the damper blade 195. Each pivot shaft 245 extends inward from lateral edges of the damper blade 195 and has an end that is rotatably coupled to the attachment portion 240. In the illustrated embodiment, the portion of the pivot shaft 245 that is coupled to the damper blade 195 is a half shaft. In some embodiments, the pivot members 230 may include a single pivot shaft that extends between the attachment portions 240 across the width of the damper blade 195.

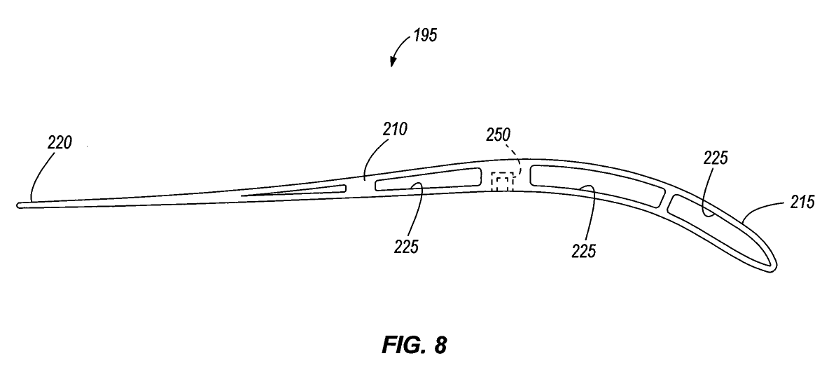

As illustrated in FIG. 8, the damper blade 195 includes inserts 250 (one shown) that extend into the damper blade 195 from an underside of the body 210. FIG. 7 shows that the inserts 250 receive fasteners 255 (e.g., bolts, screws, etc.) that attach the pivot members 230 to the damper blade 195. In embodiments in which the damper blade 195 is formed by a molding process, the inserts can be co-molded into the damper blade 195. In other embodiments, the damper blade 195 can be molded with holes in the body 210 such that the inserts 250 can be separately formed and inserted into the body 210 in an interference fit. In these embodiments, the inserts 250 can be formed from the same or a different material as the material of the damper blade 195. In still other embodiments, the inserts 250 can be machined into the damper blade 195.

The damper assembly 65 also includes a motor 260 (FIG. 7) and stop members 265 (FIGS. 3-6). As illustrated in FIG. 7, the motor 260 is coupled to one of the pivot members 230 to rotate the pivot shafts 245 within the corresponding attachment portions 240 so that the damper blade 195 can be pivoted between the open position and the closed position. The illustrated motor 260 is an electrical motor that is in communication with a power source (e.g., battery, etc.) of the transport unit 10, although other prime movers are also possible and considered herein.

As shown in FIGS. 3-6, the stop members 265 are coupled to the side wall portions 100. Each stop member 265 extends inward from the corresponding side wall portion 100, and is spaced apart from the upper wall portion 90 so that when the damper blade 195 is in the open position, the damper blade 195 extends slightly downward toward the outlet 85 to direct the airflow from the blower assembly efficiently through the outlet 85. Engagement of the second end 220 with the stop members 265 further inhibits contact between the first end 215 and the blower assembly 75. In some embodiments, the stop members 265 can be spaced apart from the upper wall portion 90 so that when the damper blade 195 is in the open position, the damper blade 195 extends substantially horizontally toward the outlet 85. In other embodiments, the stop members 265 can be spaced apart from the upper wall portion 90 so that when the damper blade 195 is in the open position, the damper blade 195 extends slightly upward toward the outlet 85. In still other embodiments, one stop member can be used.

In operation, the blower assembly 75 generates the airflow through the compartment 30 and into the space 25 when the refrigeration system 35 is in the refrigeration mode. Generally, air from the conditioned space 25 enters the compartment 30 through the first opening 50 and is conditioned by the refrigeration system 35. The airflow flows from the evaporator 57 enters the blower assembly 75 through an area defined by the side walls 40 of the compartment 30, the side wall portions 100 of the housing 70, and the inlet members 190. The inlet members 190 efficiently direct the conditioned airflow through the inlets 80 into the hollow portion 150 of the blower assembly75. The airflow is discharged by the blower member 145 toward the second opening 55 and the outlet 85. As illustrated by the arrow 270 in FIG. 6, the blower member 145 rotates counter-clockwise, and the airflow flows outward from the hollow portion 150 across the fan blades 175 toward the outlet 85.

The airfoil shape of the body 210 allows the damper blade 195 to be placed very close to the blower assembly 75 without adversely affecting the efficiency of the blower assembly 75, and without taking up a substantial amount of space in the compartment 30. The airfoil-shaped damper blade 195 also allows the ledge portion 130 to be relatively small, and allows the blower assembly 75 to be placed in close proximity to the outlet 85. In addition, the offset pivot axis 235 permits the damper blade 195 to engage the upper wall portion 90 and the ledge portion 130 when the damper blade 195 is pivoted to the closed position without the damper blade 195 contacting the blower member 145. The damper blade 195 further enables the use of a larger blower assembly 75 in the housing 70.

The damper blade 195 is pivoted to the open position when the refrigeration system 35 is in the refrigeration mode to direct the conditioned airflow generated by the blower assembly 75 into the space 25 to condition the cargo. The damper blade 195 contacts the stop members 265 when the damper blade 195 is in the open position. The airfoil-shaped damper blade 195 receives the airflow from the blower assembly 75 over a plurality of angles, and directs the airflow toward the outlet 85 in a substantially uniform horizontal direction. The airfoil shape of the damper blade 195 inhibits formation of air vortices (i.e. rotation of the airflow) between the blower assembly 75 and the outlet 85 when the damper blade 195 is in the open position. The angular displacement of the second wall segment 110 between the first and third wall segments 105, 115 further provides efficient airflow toward the outlet 85.

The curved first end 215 of the damper blade 195 further facilitates a direct, substantially horizontal airflow from the blower assembly 75 through the outlet 85. In particular, the curvature of the first end 215 substantially aligns with the direction of air discharged or emerging from the blower member 145 along the perimeter of the blower assembly 75 so that the airflow flows in close proximity to the damper blade 195 along both sides of the body 210. In this manner, the velocity of the airflow generated by the blower assembly 75 is substantially maintained between the blower member 145 and the outlet 85.

In some embodiments, the blower member 145 rotates continuously when the prime mover is operating, thereby continuously generating the airflow. When the refrigeration system 35 is in the defrost mode, the warm, defrosting evaporator 57 heats air that passes over the evaporator 57. The damper blade 195 is pivoted to the closed position when the refrigeration system 35 is in the defrost mode to inhibit flow of the heated airflow from the blower assembly 75 through the outlet 85 and into the space 25. The first end 215 contacts the upper wall portion 90 and the second end 220 contacts the ledge portion 130 when the damper blade 195 is in the closed position. As a result the airflow generated by the blower assembly 75 circulates within the housing 70 between the blower assembly 75 and the housing cover 95 and generally around the perimeter of the blower member 145, and does not pass through the outlet 85 into the space 25.

Various features and advantages of the invention are set forth in the following claims.

What is claimed is:

1. A damper assembly for a transport unit defining a space and including a refrigeration system configured to condition the space, the damper assembly comprising:
a housing coupled to the transport unit and including an inlet and an outlet in communication with the conditioned space;
a blower assembly disposed in the housing and in communication with the inlet and the outlet, the blower assembly including a rotatable blower member configured to generate an airflow from the inlet toward the outlet;
an airfoil-shaped damper blade pivotally coupled to the housing about an axis offset from a center of the damper blade, the damper blade positioned adjacent and in close proximity to the blower member and further positioned between the blower assembly and the outlet, the damper blade pivotable about the axis between an open position and a closed position to selectively direct the airflow through the outlet.

2. The damper assembly of claim 1, wherein the damper blade includes a first end with a thickness and a second end with a thickness substantially less than the thickness of the first end.

3. The damper assembly of claim 2, wherein the damper blade is tapered from the first end to the second end.

4. The damper assembly of claim 2, wherein the first end contacts an upper portion of the housing and the second end contacts a lower portion of the housing when the damper blade is in the closed position.

5. The damper assembly of claim 1, wherein the first end of the damper blade is positioned approximately 20 mm from the blower member when the damper blade is in the open position.

6. The damper assembly of claim 1, wherein the airflow is directed through the outlet and into the conditioned space when the damper blade is pivoted to the open position, and wherein the airflow is inhibited from passing through the outlet when the damper blade is pivoted to the closed position.

7. The damper assembly of claim 1, wherein the damper blade extends across a width of the housing.

8. The damper assembly of claim 1, wherein the housing includes a stop member, and wherein the second end of the damper blade contacts the stop member when the damper blade is in the open position.

9. A damper assembly for a transport unit defining a space and including a refrigeration system configured to condition the space, the damper assembly comprising:
a housing coupled to the transport unit and including an inlet and an outlet in communication with the conditioned space, the housing further including an upper portion and a lower portion;
a blower assembly disposed in the housing and in communication with the inlet and the outlet, the blower assembly including a rotatable blower member configured to generate an airflow from the inlet toward the outlet;
a damper blade including a shaft pivotally coupled to the housing and defining an axis, the damper blade positioned adjacent and in close proximity to the blower member and pivotable about the axis between an open position and a closed position, the damper blade further including a first end having a thickness and a second end having a thickness substantially less than the thickness of the first end such that when the damper blade is in the open position, the first end is configured to receive the airflow from the blower assembly over a plurality of angles to direct the airflow through the outlet in a substantially uniform horizontal direction.

10. The damper assembly of claim 9, wherein the axis is offset from a center of the damper blade.

11. The damper assembly of claim 9, wherein the damper blade is further positioned between the blower assembly and the outlet to selectively direct the airflow through the outlet.

12. The damper assembly of claim 11, wherein the first end contacts the upper portion and the second end contacts the lower portion when the damper blade is in the closed position.

13. The damper assembly of claim 11, wherein the airflow is directed through the outlet and into the conditioned space when the damper blade is pivoted to the open position, and wherein the airflow is inhibited from passing through the outlet when the damper blade is pivoted to the closed position.

14. The damper assembly of claim 9, wherein the damper blade is tapered from the first end to the second end.

15. The damper assembly of claim 9, wherein the first end of the damper blade is positioned approximately 20 mm from the blower member when the damper blade is in the open position.

16. The damper assembly of claim 9, wherein the damper blade extends across a width of the housing.

17. The damper assembly of claim 9, wherein the housing includes a stop member, and wherein the second end of the damper blade contacts the stop member when the damper blade is in the open position.

18. The damper assembly of claim 9, further comprising a motor coupled to the shaft and configured to pivot the damper blade between the open position and the closed position.

19. The damper assembly of claim 9, wherein the refrigeration system includes a refrigeration mode and a defrost mode, and wherein the damper blade is pivoted to the open position to direct air through the outlet and into the conditioned space in response to the refrigeration system being operated in the refrigeration mode.

20. The damper assembly of claim 19, wherein the damper blade is pivoted to the closed position to inhibit air from flowing through the outlet and into the conditioned space in response to the refrigeration system being operated in the defrost mode.

21. A damper assembly for a transport unit defining a space and including a refrigeration system configured to condition the space, the damper assembly comprising:
a housing coupled to the transport unit and including an inlet and an outlet in communication with the conditioned space, the housing further including an upper portion and a lower portion;
a blower assembly disposed in the housing and in communication with the inlet and the outlet, the blower assembly including a rotatable blower member configured to generate an airflow from the inlet toward the outlet;
an airfoil-shaped damper blade including a shaft pivotally coupled to the housing and defining an axis offset from a center of the damper blade, the damper blade positioned adjacent and in close proximity to the blower member and pivotable about the axis between an open position and a closed position to selectively direct the airflow through the outlet, the damper blade further positioned between the blower assembly and the outlet, the damper blade further including a first end having a thickness and a second end having a thickness substantially less than the thickness of the first end such that when the damper blade is in the open position, the first end is configured to receive the airflow from the blower assembly over a plurality of angles to direct the airflow through the outlet in a substantially uniform horizontal direction.
